(19) United States
(12) Patent Application Publication
(10) Pub. No.: US 2014/0021004 A1
(43) Pub. Date: Jan. 23, 2014

(54) RATCHET BASE STRUCTURE FOR A BICYCLE

(71) Applicant: Bin Chang, Taichung City (TW)

(72) Inventor: Bin Chang, Taichung City (TW)

(21) Appl. No.: 13/591,240

(22) Filed: Aug. 22, 2012

(30) Foreign Application Priority Data
Jul. 18, 2012 (TW) 101125938

(51) Int. Cl. F16D 13/60

(52) U.S. Cl. 192/108

(57) ABSTRACT

A ratchet base structure for a bicycle includes a ratchet base and a plurality of enforcing ribs, The ratchet base has a plurality of positioning protrusions and locating protrusions. A plurality of cavities is adjacent to the locating protrusions. Each locating protrusions has an attaching face. Each enforcing rib has an abutting part connected to a fastening part via a connecting part. The fastening part is passed through the cavity to connect to the ratchet base so that the enforcing ribs are assembled on the ratchet base. Under this arrangement, when the flying wheel is rotated, the enforcing ribs suffer a torsion force from the flying wheel so as to avoid the locating protrusions from damaging.

### BACKGROUND OF THE INVENTION

1. Field of the Invention

The present invention relates to a ratchet base structure, and more particularly to a ratchet base structure for a bicycle.

2. Description of Related Art

A derailleur system of a bicycle comprises a flying wheel, a chain wheel, a chain, a derailleur, a bar end shifter and a plurality of cables. By the combination of the major gear and the gears on the flying wheel, a user can adjust the derailleur system to achieve an expected speed of the bicycle.

Recently, since weight lightening becomes the concept of the bicycle designing, most of the bicycles are made of aluminum alloys or carbon fiber composite material. Most of the ratchet bases, which are connected to wheel hubs are made of aluminum alloys, too; In contrast, most of the flying wheels, which are engagingly assembled on the ratchet bases are made of iron or other materials which are harder and more rigid.

Allowable derivations of the lengths, widths, sizes or other intrinsic numerical properties between the product and the model, so called as the machining allowances, are applied during the bicycle production, so that the user can connect the protrusions of the ratchet base with the engaging holes of the flying wheel more conveniently. However, when the user rides the bicycle, the flying wheel would continuously collide to the ratchet base because of the machining allowance. In addition, if the user over forces on the pedals of the bicycle, the flying wheel would over force on the ratchet base. These disadvantages would cause a periphery of the protrusions of the ratchet and the engaging hole of the flying wheel being damaged and would further reduce the driving performance between the flying wheel and the ratchet base.

A conventional ratchet base structure comprises a ratchet base and a plurality of enforcing slices, the ratchet base having a plurality of engaging portions and a plurality of indentations, each engaging portion having a resisting part, an engaging face defined adjacent to the indentation, the engaging face having a groove recessed thereon, the enforcing slices being made of a metal material which has a higher constructional strength as compared to the ratchet body, each enforcing slice lockingly engaged with each corresponding groove, each enforcing slice further having a corresponding working face, each working face corresponding to each corresponding engaging face, the working face assembled on a chain set to drive the ratchet base. Under this arrangement, the enforcing slices increase the constructional strength of the ratchet base, so that the life of the ratchet base is extended.

However, the conventional ratchet base structure has the following disadvantage. After a long-term use, the enforcing slices will depart from the ratchet base because the enforcing slices do not connect to the ratchet base well.

The present invention has arisen to mitigate and/or obviate the disadvantages of the conventional.

### SUMMARY OF THE INVENTION

The main objective of the present invention is to provide an improved ratchet base structure.

To achieve the objective, a ratchet base structure for a bicycle comprises a ratchet base and a plurality of enforcing ribs, the ratchet base having a plurality of positioning protrusions and a plurality of locating protrusions extruded around an outer periphery thereof, a plurality of cavities being adjacent to the locating protrusions, each locating protrusions having an attaching face defined thereon, each attaching face corresponding to each corresponding cavity, each enforcing rib having an abutting part, a fastening part and a connecting part, the abutting part connected to the fastening part via the connecting part, the fastening part passed through the cavity to fixingly connect to the ratchet base, one side of the connecting part attached to the attaching face of the locating protrusion, the abutting part covering the cavity, the abutting part and the locating protrusion formed an engaging assembly. Wherein, the ratchet base structure for a bicycle has a plurality of bolts; each fastening part has a locking hole opened thereon; each locking hole corresponds to each corresponding bolt; the bolt is passed through the corresponding locking hole and further inserted into the corresponding locating protrusion so that the enforcing ribs are fastened on the ratchet base via the bolts; the abutting part, the connecting part and the fastening part are integrated into the enforcing rib as one piece; the abutting part is extended from one end of the connecting part and the fastening part is extended from another end of the connecting part; the locating protrusions and the positioning protrusions are defined alternatively around the ratchet base.

Under this arrangement, a flying wheel is assembled with the ratchet base by positioning the positioning protrusions and the engaging assemblies into of the flying wheel; when the flying wheel is rotated, the enforcing ribs suffer a torsion force from the flying wheel so as to avoid the locating protrusions from damaging; in addition, the torsion force is further delivered to the attaching faces of the ratchet base so as to enhance a driving performance for a bicycle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a ratchet base structure for a bicycle of the present invention;

FIG. 2 is a perspective view of the ratchet base structure for a bicycle;

FIG. 3 is a cross-sectional view along line 3-3 shown in FIG. 2;

FIG. 4 is a cross-sectional view along line 3-3 shown in FIG. 2 for showing a relationship between a bolt, an enforcing rib and a ratchet base;

FIG. 5 is a perspective view for showing the present invention is assembled with a flying wheel; and

FIG. 6 is a cross-sectional view for showing the present invention is assembled with the flying wheel.

### DETAILED DESCRIPTION OF THE INVENTION

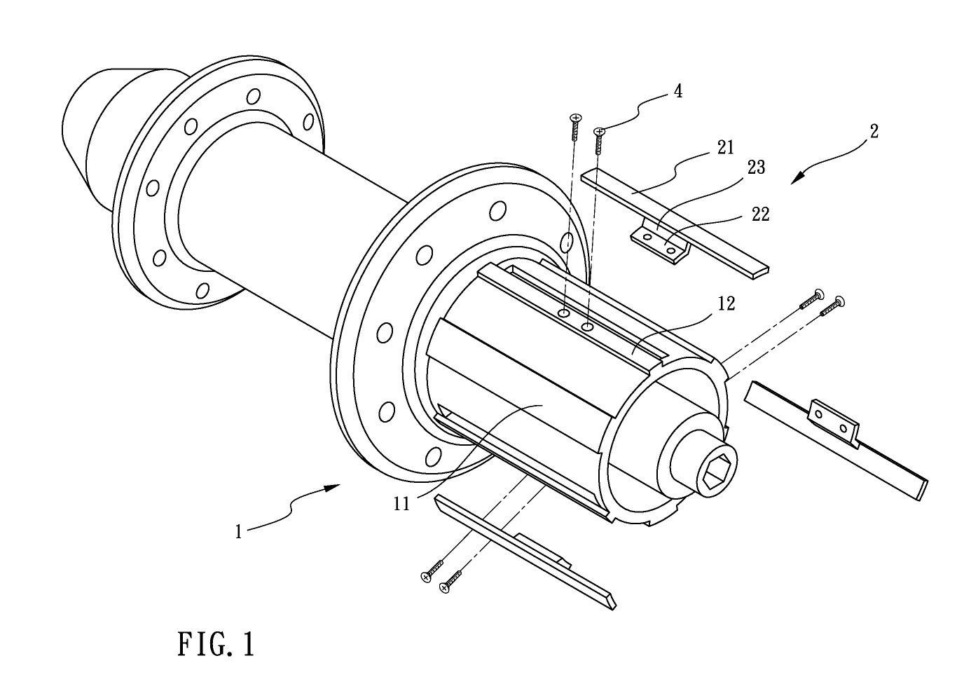

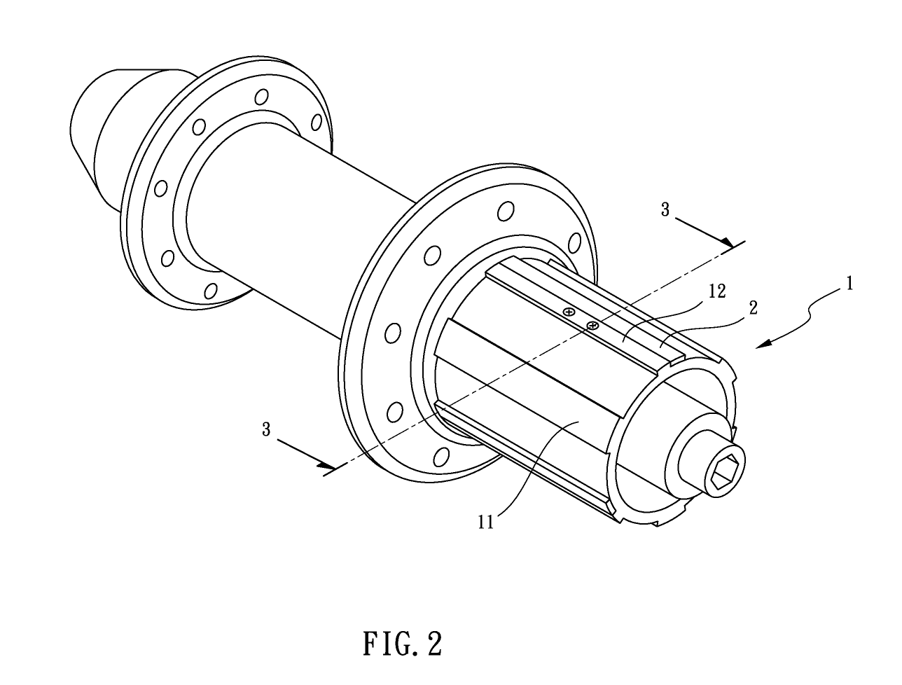

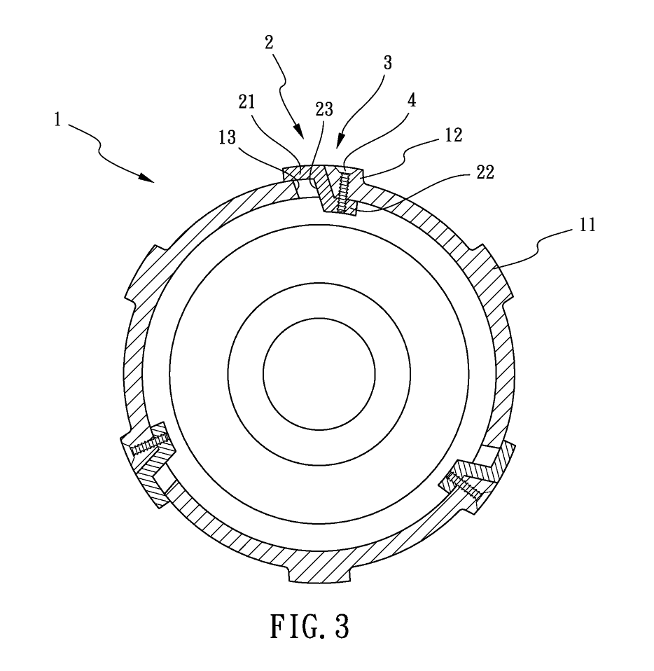

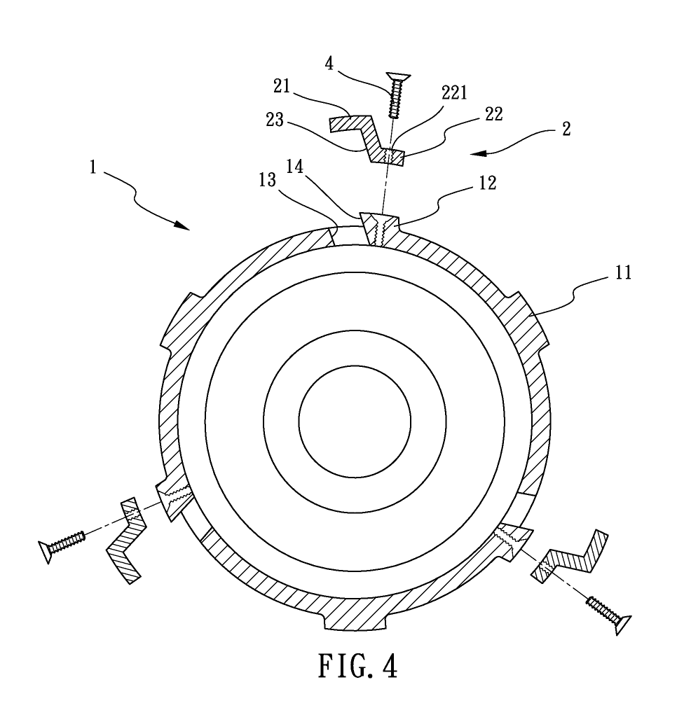

Referring to FIGS. 1-6, a ratchet base structure for a bicycle in accordance with the present invention comprises a ratchet base 1 and a plurality of enforcing ribs 2.

The ratchet base 1 has a plurality of positioning protrusions 11 and a plurality of locating protrusions 12 extruded around an outer periphery thereof. A plurality of cavities 13 is adjacent to the locating protrusions 12. Each locating protrusions 12 has an attaching face 14 defined thereon. Each attaching face 14 corresponds to each corresponding cavity 13.

Each enforcing rib 2 has an abutting part 21, a fastening part 22 and a connecting part 23. The abutting part 21 is connected to the fastening part 22 via the connecting part 23. The fastening part 22 is passed through the cavity 13 to fixingly connect to the ratchet base 1. One side of the connecting part 23 is attached to the attaching face 14 of the locating protrusion 12. The abutting part 21 covers the cavity 13. The abutting part 21 and the locating protrusion 12 form an engaging assembly 3.

Under this arrangement, a flying wheel 10 is assembled with the ratchet base 1 by positioning the positioning protrusions 11 and the engaging assemblies 3 into a plurality of driving grooves (not shown) of the flying wheel 10. When the flying wheel 10 is rotated, the enforcing ribs 2 suffer a torsion force from the flying wheel 10 so as to avoid the locating protrusions 12 from damaging. The torsion force is further delivered to the attaching faces 14 of the ratchet base 1 so as to enhance a driving performance for a bicycle.

The present invention further has the following characteristics:

1. The present invention has a plurality of bolts 4. Each fastening part 22 has a locking hole 221 opened thereon. Each locating protrusion 12 has a screwing hole (not shown) opened thereon. Each locking hole 221 corresponds to each corresponding bolt 4. Each bolt 4 is passed through each corresponding locking hole 221 and further inserted into each corresponding screwing hole of the locating protrusion 12 so that the enforcing ribs 2 are fastened on the ratchet base 1 via the bolts 4.

2. The abutting part 21, the connecting part 23 and the fastening part 22 are integrated into the enforcing rib 2 as one piece so as to extend the life of the enforcing ribs 2.

3. For each enforcing rib 2, the abutting part 21 is extended from one end of the connecting part 23 and the fastening part 22 is extended from another end of the connecting part 23, so that the fastening part 22 is inserted into the ratchet base 1 and the abutting part 21 is exposed from the ratchet base 1 so as to firmly assemble the enforcing ribs 2 on the ratchet base 1.

4. The locating protrusions 12 and the positioning protrusions 11 are defined alternatively around the ratchet base 1.

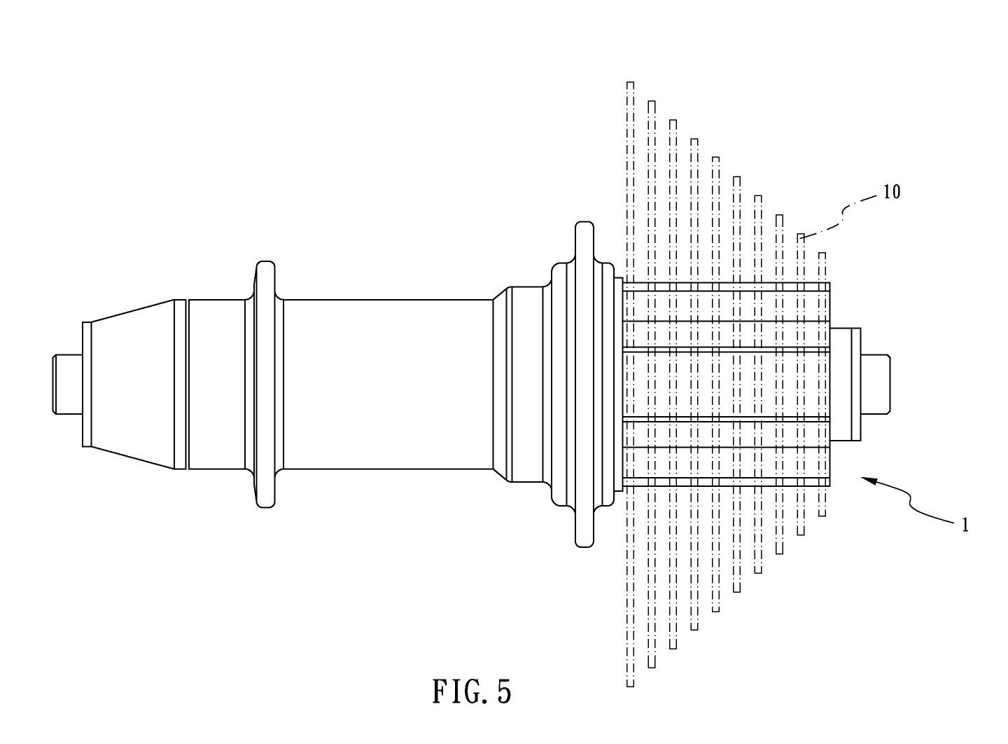

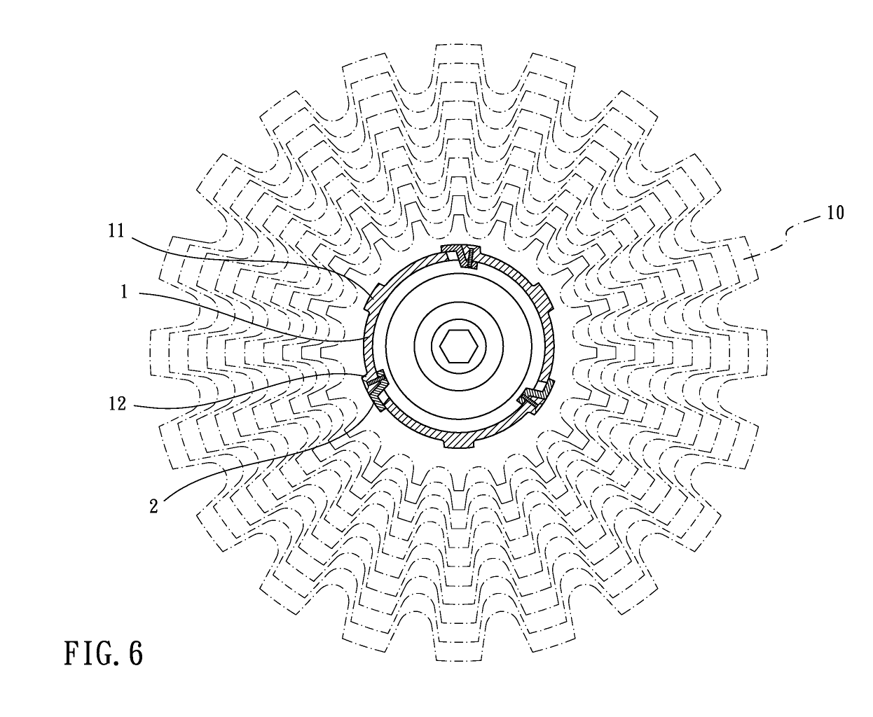

Referring to FIGS. 5-6, the assembling procedures of the present invention are described as following. Firstly, the fastening part 22 of the enforcing rib 2 is passed through the cavity 13 and is inserted into the ratchet base 1. Secondly, the bolt 4 is passed through the locking hole 221 of the fastening part 22 and is further inserted into the locating protrusion 12. Finally, the enforcing ribs 2 are firmly locked on the ratchet base 1, the connecting part 23 of the enforcing rib 2 is closely attached to the attaching face 14 of the ratchet base 1, and the abutting part 21 of the enforcing rib 2 covers the cavity 13 completely. Therefore, the enforcing ribs 2 do not easily disengage with the ratchet base 1 after long-term use.

When the flying wheel 10 is assembled with the ratchet base 1, a wall of the driving groove of the flying wheel 10 is abutted against the abutting part 21 of the enforcing rib 2 and the connecting part 23 of the enforcing rib 2 is attached closely to the attaching face 14. Under this arrangement, the flying wheel 10 is able to effectively deliver the torsion force to the ratchet base 1 so as to drive the bicycle smoothly. Moreover, the torsion force come from the flying wheel 10 is applied directly on the abutting parts 21 of the enforcing ribs 2, the enforcing ribs 2 will be damaged rather than the locating protrusions 12 of the ratchet base 1. As a result, the life of the ratchet base 1 is extended.

All in all, in the present invention, even after a long-term use, the enforcing ribs 2 do not depart from the ratchet base 1 because the enforcing ribs 2 engage with the ratchet base 1 well.

Although the invention has been explained in relation to its preferred embodiment, it is to be understood that many other possible modifications and variations can be made without departing from the spirit and scope of the invention as hereinafter claimed.

What is claimed is:

1. A ratchet base structure for a bicycle comprising:
a ratchet base and a plurality of enforcing ribs;
the ratchet base having a plurality of positioning protrusions and a plurality of locating protrusions extruded around an outer periphery thereof, a plurality of cavities being adjacent to the locating protrusions, each locating protrusions having an attaching face defined thereon, each attaching face corresponding to each corresponding cavity; and
each enforcing rib having an abutting part, a fastening part and a connecting part, the abutting part connected to the fastening part via the connecting part, the fastening part passed through the cavity to fixingly connect to the ratchet base, one side of the connecting part attached to the attaching face of the locating protrusion, the abutting part covering the cavity, the abutting part and the locating protrusion formed an engaging assembly;
wherein a flying wheel is assembled with the ratchet base by positioning the positioning protrusions and the engaging assemblies into of the flying wheel; when the flying wheel is rotated, the enforcing ribs suffer a torsion force from the flying wheel so as to avoid the locating protrusions from damaging; in addition, the torsion force is further delivered to the attaching faces of the ratchet base so as to enhance a driving performance for a bicycle.

2. The ratchet base structure for a bicycle as claimed in claim 1, wherein the ratchet base structure for a bicycle has a plurality of bolts; each fastening part has a locking hole opened thereon; each locking hole corresponds to each corresponding bolt; the bolt is passed through the corresponding locking hole and further inserted into the corresponding locating protrusion so that the enforcing ribs are fastened on the ratchet base via the bolts.

3. The ratchet base structure for a bicycle as claimed in claim 1, wherein the abutting part, the connecting part and the fastening part are integrated into the enforcing rib as one piece.

4. The ratchet base structure for a bicycle as claimed in claim 1, wherein the abutting part is extended from one end of the connecting part and the fastening part is extended from another end of the connecting part.

5. The ratchet base structure for a bicycle as claimed in claim 1, wherein the locating protrusions and the positioning protrusions are defined alternatively around the ratchet base.
